(19) United States
(12) Patent Application Publication
(10) Pub. No.: US 2024/0428179 A1
(43) Pub. Date: Dec. 26, 2024

(54) INFORMATION PROVIDING DEVICE

(71) Applicant: TOYOTA JIDOSHA KABUSHIKI KAISHA, Toyota-shi (JP)

(72) Inventors: Hideyuki TAKAKI, Okazaki-shi (JP); Yusuke TSUMITA, Kashiwa-shi (JP); Satoshi KAJIYAMA, Ibaraki-shi (JP); Yasuhiro KOBATAKE, Nagoya-shi (JP); Takafumi YAMADAIRA, Nagoya-shi (JP); Kumiko HAYASHI, Nagoya-shi (JP); Tomoya KAJIKAWA, Nagoya-shi (JP)

(73) Assignee: TOYOTA JIDOSHA KABUSHIKI KAISHA, Toyota-shi (JP)

(21) Appl. No.: 18/829,686

(22) Filed: Sep. 10, 2024

(30) Foreign Application Priority Data
Feb. 26, 2023 (JP) 2023-219958

(51) Int. Cl. G06Q 10/0833

(52) U.S. Cl. CPC G06Q 10/0833

(57) ABSTRACT

An information providing device includes a control unit that acquires progress data indicating a movement path of the vehicle from when the vehicle purchased by a certain user is shipped to when the vehicle is delivered, and outputs the acquired progress data to a terminal device of the user. The control unit detects, as the first section, a section that satisfies a predetermined first condition among one or more sections included in the movement path, and performs control for changing the display mode of the first section on the movement path indicated by the progress data for the detected first section.

### CROSS-REFERENCE TO RELATED APPLICATION

This application claims priority to Japanese Patent Application No. 2023-219958 filed on Dec. 26, 2023, incorporated herein by reference in its entirety.

### BACKGROUND

### 1. Technical Field

The present disclosure relates to an information providing device.

### 2. Description of Related Art

Japanese Unexamined Patent Application Publication No. 2002-297954 (JP 2002-297954 A) discloses a vehicle information providing device that provides vehicle information online, using an information providing device belonging to an automobile manufacturer and a user terminal owned by a user.

### SUMMARY

With respect to a vehicle purchased by a user, prior to delivery, it is conceivable to provide the user who is a purchaser with progress status of the delivery of the vehicle. In a case in which a movement path of the vehicle before delivery is displayed on a terminal device of the user, as information relating to the progress status of delivery, and the movement path of the vehicle, being transported from a factory to a shop of a dealer where the user has signed a contract, for example, includes a section traveling away from this shop, a section in which moving speed of the vehicle is slow, or some other section that would cause the user to feel suspicious at first glance, the user does not know whether a system side is recognizing the movement path, and may feel dissatisfaction. The same applies to a section in which a delay or the like has occurred in transportation of the vehicle.

It is an object of the present disclosure to reduce the likelihood that a user will feel dissatisfied with progress status of delivery of a vehicle.

An information providing device according to the present disclosure includes:

a control unit that acquires progress data indicating a movement path of a vehicle, from when the vehicle purchased by a certain user is shipped, to when the vehicle is delivered, and outputs the progress data that is acquired to a terminal device of the user.

The control unit detects, from among one or more sections included in the movement path, a section that satisfies a predetermined first condition as a first section, and performs control for changing a display mode of the first section on the movement path indicated by the progress data, with respect to the first section that is detected.

According to the present disclosure, the likelihood that a user will feel dissatisfied with progress status of delivery of a vehicle can be reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of a system according to an embodiment of the present disclosure;

FIG. 2 is a block diagram illustrating a configuration of an information providing device according to an embodiment of the present disclosure;

FIG. 3 is a block-diagram illustrating a configuration of a terminal device according to an embodiment of the present disclosure; and

FIG. 4 is a flowchart illustrating an operation of a system according to an embodiment of the present disclosure.

### DETAILED DESCRIPTION OF EMBODIMENTS

Hereinafter, embodiments of the present disclosure will be described below with reference to the drawings.

In each drawing, the same or corresponding portions are denoted by the same reference signs. In the description of the present embodiment, description of the same or corresponding components will be appropriately omitted or simplified.

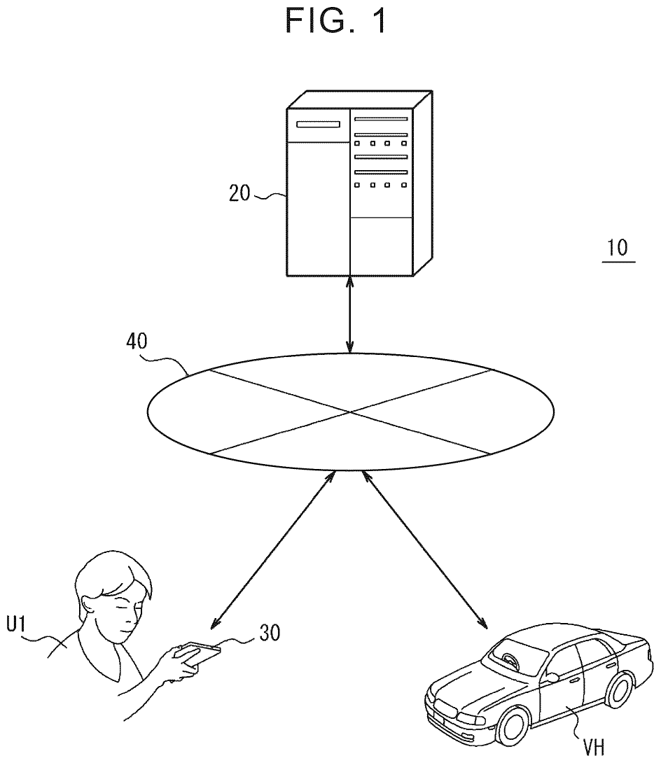

The configuration of a system 10 according to the present embodiment will be described with reference to FIG. 1.

The system 10 includes at least one information providing device 20, at least one terminal device 30, and at least one vehicle VH. A plurality of information providing devices 20, terminal devices 30, and the vehicle VH may be provided.

The information providing device 20 can communicate with the terminal device 30 and the vehicle VH via the network 40.

The information providing device 20 is installed in a facility such as a data center. The information providing device 20 is, for example, a server belonging to a cloud computing system or another computing system.

The terminal device 30 is held by a user U1. In the present embodiment, the user U1 is a purchaser of the vehicle VH. The terminal device 30 is, for example, a mobile device such as a mobile phone, a smartphone, or a tablet, or a PC. “PC” is an abbreviation for personal computer.

Vehicle VH can be any type of vehicle, such as, for example, a gas-powered vehicle, a die-powered vehicle, an HEV, PHEV, BEV, or an FCEV. “HEV” is an abbreviation for hybrid electric vehicle. “PHEV” is an abbreviation for plug-in hybrid electric vehicle. “BEV” is an abbreviation for battery electric vehicle. “FCEV” is an abbreviation for fuel cell electric vehicle. The vehicle VH is a private vehicle in the present embodiment, but is not limited thereto, and may be any vehicle as long as it is purchased by a user U1 and can track a movement path to delivery. The vehicle VH may be driven by a driver, or may be an AV in which driving is automated at any level. “AV” stands for autonomous vehicle. The level of autonomous driving is, for example, one of levels 1 to 5 in the SAE leveling, for example. “SAE” is an abbreviation for Society of Automotive Engineers.

Network 40 includes the Internet, at least one WAN, at least one MAN, or a combination thereof. “WAN” is an abbreviation for wide area network. “MAN” is an abbreviation for metropolitan area network. The network 40 may include at least one wireless network, at least one optical network, or a combination thereof. The wireless network is, for example, an ad hoc network, a cellular network, a wireless LAN, a satellite communication network, or a terrestrial microwave network. The term “LAN” is an abbreviation for “local area network”.

The outline of the present embodiment will be described with reference to FIG. 1.

In general, a user who has purchased a vehicle waits for the arrival of the vehicle that the user has purchased, and desires that the vehicle be delivered as soon as possible. Therefore, it is important to create a “feeling of advancing now” or a “feeling of not stopping” when displaying a movement path of a vehicle before delivery to a user. However, in a route for transporting a vehicle before delivery, not only a section in which the vehicle moves forward, but also a section in which the vehicle moves away from the store or a section in which the moving speed of the vehicle is slow, for example, may occur due to an actual terrain, a logistics strategy, or the like. However, if these sections are directly displayed to the purchaser as the movement path of the vehicle, the “feeling of being advanced now” or the “feeling of not being stopped” may be impaired, and the user may feel suspicious.

In the system 10 according to the present embodiment, the information providing device 20 outputs the acquired progress data D1 to the terminal device 30 of the user U1 by acquiring the progress data D1 indicating the movement path Mt of the vehicle VH from when the vehicle VH purchased by a certain user U1 is shipped to when the vehicle VH is delivered, and outputting the acquired progress data D1. The information providing device 20 performs control to detect a section that satisfies the predetermined first condition among the one or more sections Sc included in the movement path Mt as the first section Sc1, and to change the displaying mode of the first section Sc1 on the movement path Mt indicated by the progress data D1 with respect to the detected first section Sc1.

According to the present embodiment, when there is a section where the user U1 can be suspicious in the movement path Mt of the vehicle VH, the displaying mode is changed. Therefore, the user U1 can be assured that the user is aware of the movement of the vehicle VH that appears suspicious, even if it is recognized by the system 10. Consequently, it is possible to reduce the possibility that the user U1 feels dissatisfaction with the progress of the delivery of the vehicle VH.

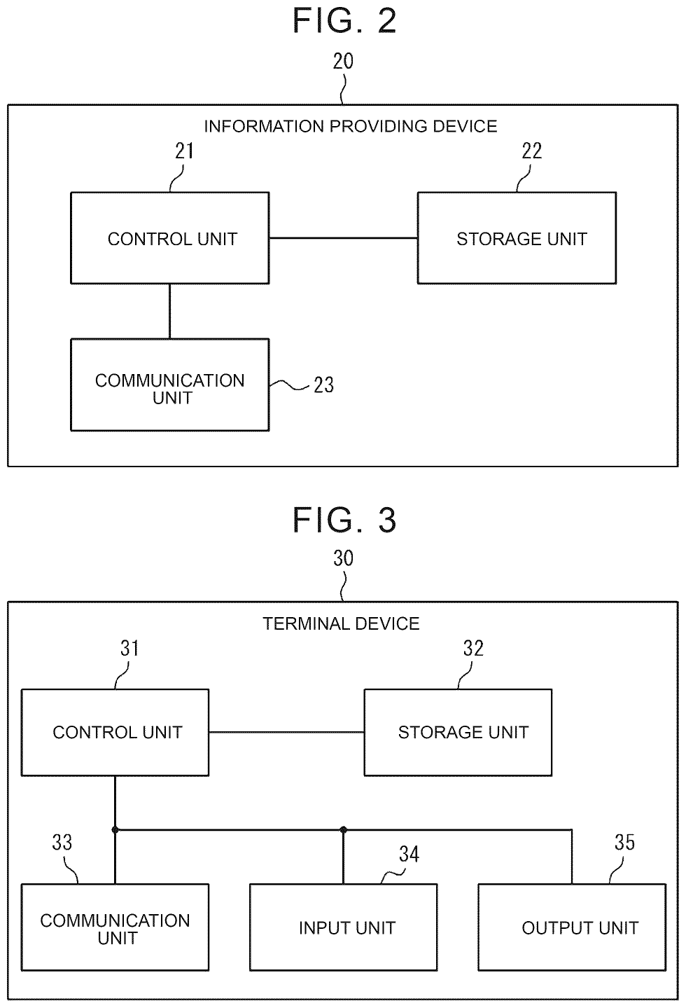

A configuration of the information providing device 20 according to the present embodiment will be described with reference to FIG. 2.

The information providing device 20 includes a control unit 21, a storage unit 22, and a communication unit 23.

The control unit 21 includes at least one processor, at least one programmable circuit, at least one dedicated circuit, or any combination thereof. The processor is a general-purpose processor such as a CPU or a GPU, or a dedicated processor specialized for a specific process. The term “CPU” is an abbreviation for “central processing unit”. “GPU” is an abbreviation for graphics processing unit. The programmable circuit is, for example, an FPGA. The term “FPGA” is an abbreviation for “field-programmable gate array”. The dedicated circuit is, for example, an ASIC. The term “ASIC” is an abbreviation for “application specific integrated circuit”. The control unit 21 executes processing related to the operation of the information providing device 20 while controlling each unit of the information providing device 20.

The storage unit 22 includes at least one semiconductor memory, at least one magnetic memory, at least one optical memory, or a combination of at least two of them. The semiconductor memory is, for example, a RAM or a ROM. The term “RAM” is an abbreviation for “random access memory”. The term “ROM” is an abbreviation for “read-only memory”. The RAM is, for example, a static random access memory (SRAM) or a dynamic random access memory (DRAM). “SRAM” is an abbreviation for static random access memory. The term “DRAM” is an abbreviation for “dynamic random access memory”. The ROM is, for example, an EEPROM. The term “EEPROM” is an abbreviation for “electrically erasable programmable read-only memory”. The storage unit 22 functions as, for example, a main storage device, an auxiliary storage device, or a cache memory. The storage unit 22 stores data used for the operation of the information providing device 20 and data obtained by the operation of the information providing device 20. In the storage unit 22, schedule data D2 indicating a schedule until the vehicle VH is delivered may be stored in association with the identification ID of the vehicle VH.

A map database may be constructed in the storage unit 22. The map database is a database that stores map information Dm of the entire area where the vehicle VH may travel from shipping to delivery of the vehicle. The map information Dm includes, for example, information indicating a speed limit of a road in the area. For example, in the vicinity of a port where imported vehicles are carried, the speed limit is often limited to a low level, and customs clearance procedures may be time consuming. Thus, the map information Dm may include information indicating the location of the port in the area. In addition, when a plurality of vehicles including a vehicle VH are transported by one truck, the truck may stop at a store other than the store that delivers the vehicle VH. Therefore, the map information Dm may include information on a location where the vehicle VH may stop, such as a store other than the dealer contracted by the user U1. The map information Dm may include information of a particular area or area where the vehicle needs to be bypassed, where the vehicle is prohibited from traveling by law or the like.

The communication unit 23 includes at least one communication interface. The communication interface is, for example, a LAN interface. The communication unit 23 receives data used for the operation of the information providing device 20 and transmits data obtained by the operation of the information providing device 20. In the present embodiment, the communication unit 23 communicates with the terminal device 30 and the vehicle VH.

The function of the information providing device 20 is realized by executing the program according to the present embodiment by a processor serving as the control unit 21. That is, the function of the information providing device 20 is realized by software. The program causes the computer to execute the operation of the information providing device 20, thereby causing the computer to function as the information providing device 20. That is, the computer functions as the information providing device 20 by executing the operation of the information providing device 20 in accordance with the program.

The program can be stored in a non-transitory computer-readable medium. The non-transitory computer-readable medium is, for example, a flash memory, a magnetic recording device, an optical disc, an opto-magnetic recording medium, or a ROM. The distribution of the program is carried out, for example, by selling, transferring, or renting a portable medium such as an SD card, a DVD, or a CD-ROM in which the program is stored. The term “SD” is an abbreviation for “secure digital”. “DVD” is an abbreviation for digital versatile disc. The term “CD-ROM” is an abbreviation for “compact disc read-only memory”. The program may be stored in the storage of the server and transferred from the server to other computers to distribute the program. The program may be provided as a program product.

The computer temporarily stores the program stored in the portable medium or the program transferred from the server in the main storage device, for example. The computer then causes the processor to read the program stored in the main storage device, and causes the processor to execute processes in accordance with the read program. The computer may read the program directly from the portable medium and execute processes in accordance with the program. The computer may execute the processes in accordance with the received program each time the program is transferred from the server to the computer. The processes may be executed by a so-called ASP service that realizes the function only by execution instruction and result acquisition without transferring the program from the server to the computer. The term “ASP” is an abbreviation for “application service provider”. The program includes information that is used for processing by electronic computers and equivalent to a program. For example, data that is not a direct command to a computer but has the property of defining the process of the computer corresponds to the “data equivalent to a program”.

Some or all of the functions of the information providing device 20 may be realized by a programmable circuit or a dedicated circuit as the control unit 21. That is, some or all of the functions of the information providing device 20 may be realized by hardware.

The configuration of the terminal device 30 according to the present embodiment will be described with reference to FIG. 3.

The terminal device 30 includes a control unit 31, a storage unit 32, a communication unit 33, an input unit 34, and an output unit 35.

The control unit 31 includes at least one processor, at least one programmable circuit, at least one dedicated circuit, or any combination thereof. The processor is a general-purpose processor such as a CPU or a GPU, or a dedicated processor specialized for a specific process. The programmable circuit is, for example, an FPGA. The dedicated circuit is, for example, an ASIC. The control unit 31 performs processes related to the operation of the terminal device 30 while controlling each unit of the terminal device 30.

The storage unit 32 includes at least one semiconductor memory, at least one magnetic memory, at least one optical memory, or a combination of at least two of them. The semiconductor memory is, for example, a RAM or a ROM. The RAM is, for example, a static random access memory (SRAM) or a dynamic random access memory (DRAM). The ROM is, for example, an EEPROM. The storage unit 32 functions as, for example, a main storage device, an auxiliary storage device, or a cache memory. The storage unit 32 stores data used for the operation of the terminal device 30 and data acquired through the operation of the terminal device 30.

The communication unit 33 includes at least one communication interface. The communication interface is, for example, a LAN interface. The communication unit 33 receives the data used for the operation of the terminal device 30, and transmits the data acquired through the operation of the terminal device 30. In the present embodiment, the communication unit 33 communicates with the information providing device 20.

The input unit 34 includes at least one input interface. The input interface is, for example, a physical key, a capacitive key, a pointing device, a touch screen integrally provided with a display, or an audio sensor. The input unit 34 accepts an operation of inputting data used for the operation of the terminal device 30. The input unit 34 may be connected to the terminal device 30 as an external input device instead of being provided in the terminal device 30. As a connection method, for example, any method such as USB, HDMI (registered trademark), or Bluetooth (registered trademark) can be used. “USB” is an abbreviation for Universal Serial Bus. “HDMI (registered trademark)” is an abbreviation for High-Definition Multimedia Interface.

The output unit 35 includes at least one output interface. The output interface is, for example, a display. The display is, for example, an LCD or an organic EL display. “LCD” is an abbreviation for liquid crystal display. The term “EL” is an abbreviation for “electroluminescence.” In the present embodiment, the display is a touch panel that also serves as the input unit 34. The output unit 35 outputs the data acquired through the operation of the terminal device 30. In the present embodiment, the control unit 31 of the terminal device 30 displays the data acquired from the information providing device 20 on a display as the output unit 35. The output unit 35 may be connected to the terminal device 30 as an external output device instead of being provided in the terminal device 30. As a connection method, for example, any method such as USB, HDMI (registered trademark), or Bluetooth (registered trademark) can be used.

The configuration of the system 10 according to the present embodiment will be described with reference to 4. The operation corresponds to the control method according to the present embodiment.

In S1 (hereinafter, the steps of the flow chart are specified by S and numbers), the control unit 21 of the information providing device 20 acquires the progress data D1 indicating the movement path Mt of the vehicle VH from when the vehicle VH purchased by the user U1 is shipped to when the vehicle is delivered. The progress data D1 may be obtained in any manner. For example, the control unit 21 receives the position information transmitted from the vehicle VH over time via the communication unit 23, and generates the movement path Mt calculated based on the received position information. The control unit 21 acquires the generated movement path Mt as the progress data D1. Alternatively, the generation of the progress data D1 may be performed in a vehicle VH. The control unit 21 of the information providing device 20 may acquire the progress data D1 by receiving the progress data D1 transmitted from the vehicle VH.

In S2, the control unit 21 of the information providing device 20 outputs the acquired progress data D1 to the terminal device 30 of the user U1. Specifically, the control unit 21 of the information providing device 20 transmits the progress data D1 to the terminal device 30 via the communication unit 23. The terminal device 30 receives the progress data D1 transmitted from the information providing device 20, and outputs the received progress data D1. Specifically, the control unit 31 of the terminal device 30 displays the movement path Mt indicated by the progress data D1 on a display corresponding to the output unit 35. Consequently, in the terminal device 30, the movement path Mt of the vehicle VH is displayed toward the user U1. In the present embodiment, the movement path Mt indicated by the progress data D1 is displayed on the map.

In S3, the control unit 21 of the information providing device 20 detects, as the first section Sc1, a section satisfying the predetermined first condition among the one or more sections Sc included in the movement path Mt indicated by the progress data D1 acquired by S1. Specifically, the control unit 21 determines, as the first condition, whether or not the traveling direction f of the movement path Mt differs from the direction toward the destination P for each of the one or more sections Sc with the point where the vehicle VH is delivered as the destination P. For example, the control unit 21 determines whether or not the traveling direction f is a direction away from the destination P.

In S3, the control unit 21 of the information providing device 20 may monitor the moving speed v of the vehicle VH instead of specifying the traveling direction f of the movement path Mt for each of the one or more sections Sc, and determine whether the moving speed v of the vehicle VH is less than the threshold Th as the first condition. The threshold Th can be arbitrarily set as long as it is a value that is perceived as being slow from the viewpoint of the user U1, for example, a value that is significantly lower than the mean velocity of the vehicle VH on the movement path Mt.

In S4, the control unit 21 of the information providing device 20 controls the first section Sc1 detected by S2 to change the display mode of the first section Sc1 on the movement path Mt indicated by the progress data D1. Specifically, the control unit 21 of the information providing device 20 transmits information indicating the determination result in S4 to the terminal device 30 via the communication unit 23. For example, the control unit 41 transmits, on the movement path Mt, information indicating a section corresponding to the first section Sc1 to the terminal device 30.

In the present embodiment, the terminal device 30 receives, via the communication unit 33, information indicating a section corresponding to the first section Sc1 transmitted from the information providing device 20 in S4. The control unit 31 of the terminal device 30 changes the display mode of the section corresponding to the first section Sc1 on the movement path Mt displayed on the display as the output unit 35. The displaying mode of the first section Sc1 can be arbitrarily changed as long as the first section Sc1 can be distinguished from a section other than the first section Sc1. For example, the control unit 31 changes the color of the first section Sc1 on the movement path Mt to a color that differs from the section other than the first section Sc1, and outputs the color. The control unit 31 may make the first section Sc1 wider on the movement path Mt than the sections other than the first section Sc1.

As described above, the information providing device 20 according to the present embodiment performs control to detect a section that satisfies the predetermined first condition among the one or more sections Sc included in the movement path Mt of the vehicle VH as the first section Sc1, and change the display mode on the movement path Mt with respect to the detected first section Sc1.

According to this configuration, when there is a section where the user U1 can feel suspicious in the movement path Mt of the vehicle VH, the displaying mode is changed. Therefore, the user U1 can be assured that the user is aware of the movement of the vehicle VH that appears suspicious, even if it is recognized by the system 10. Consequently, it is possible to reduce the possibility that the user U1 feels dissatisfaction with the progress of the delivery of the vehicle VH.

As a modification of the present embodiment, the control unit 21 of the information providing device 20 may perform control of displaying the first section data d1 related to the first section Sc1 when the user U1 performs an operation of selecting the first section Sc1. The terminal device 30 accepts a manipulation in which the user U1 designates the first section Sc1 in the movement path Mt on the map. The operation of specifying the first section Sc1 may be performed in any manner. In one embodiment, the user U1 is performed by a GUI operation such as tapping the first section Sc1 in the movement path Mt displayed on the output unit 25. The “GUI” is an abbreviation of graphical user interface.

As a reason why the vehicle VH moves away from the conveyance destination, for example, when a plurality of vehicles including the vehicle VH are conveyed by one truck, the truck may stop at a store other than the store that delivers the vehicle VH, or may bypass a particular area or region where the vehicle is prohibited from traveling by legislation or the like. The reason why the moving speed v during the transportation of the vehicle VH is slow is that the section is in the vicinity of the port, the speed limit of the roadway is set low, or the customs clearance procedure takes a long time.

Upon detecting that the first section Sc1 is designated by the user U1, the control unit 21 of the information providing device 20 generates the first section data d1. The first period d1 may be arbitrarily generated, but may be generated, for example, in the following manner. For example, when the traveling direction f of the movement path Mt in the first section Sc1 differs from the direction toward the destination P, the control unit 21 refers to the map information Dm stored in the map database constructed in the storage unit 22, determines whether the traveling direction f is, for example, a store other than the store that delivers the vehicle VH or a detour, and generates information indicating the determined result as the first section data d1. The control unit 21 transmits the generated first period data d1 to the terminal device 30 via the communication unit 23. The terminal device 30 receives the first section data d1 transmitted from the information providing device 20 via the communication unit 33. The control unit 31 of the terminal device 30 displays the received first section data d1 in the vicinity of the section corresponding to the first section Sc1 on the movement path Mt displayed on the display as the output unit 35.

According to this modification, the information regarding the first section Sc1 is displayed for the first section Sc1 designated by the user U1. Specifically, the reason for the behavior of the vehicle VH in the first section Sc1 is displayed. Therefore, the possibility that the user U1 feels dissatisfaction is further reduced because the user U1 knows the reason for the motion of the vehicle VH that appears suspicious at first glance.

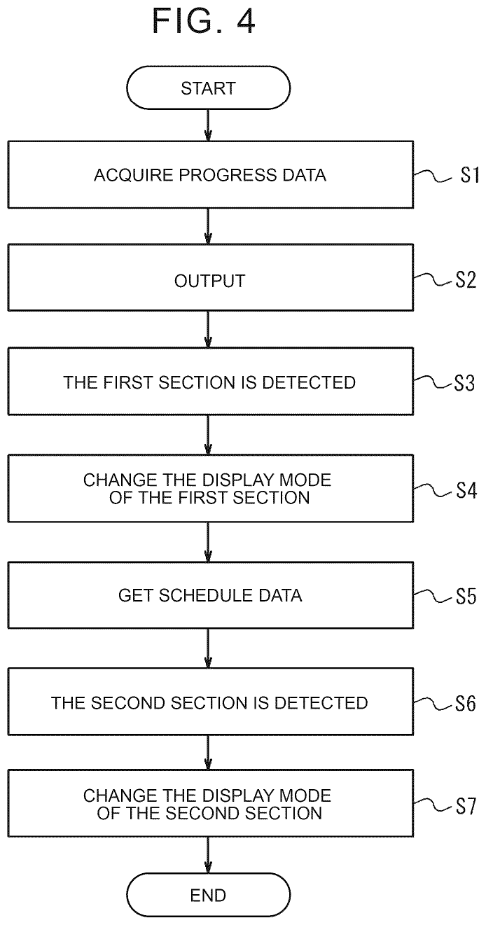

In the present embodiment, the control unit 21 of the information providing device 20 may further perform control to detect, as the second section Sc2, a section that satisfies the second condition that is different from the first condition, and change the display mode of the second section Sc2 on the movement path Mt indicated by the progress data D1 for the detected second section Sc2. Specifically, the control unit 31 may further perform the process of S5 to S7 illustrated in FIG. 4.

In S5, the control unit 21 of the information providing device 20 acquires schedule data D2 indicating a schedule until the vehicle VH is delivered. The schedule data D2 may be obtained in any manner. In the present embodiment, it is assumed that the schedule data D2 is stored in advance in the storage unit 22 in association with the identification ID of the vehicle VH. The control unit 21 of the information providing device 20 reads the schedule data D2 of the vehicle VH from the storage unit 22 based on the identification ID of the vehicle VH.

In S6, the control unit 21 of the information providing device 20 detects the second section Sc2. Specifically, the control unit 21 compares the schedule data D2 acquired by S5 with the progress data D1. In the present embodiment, it is assumed that in the movement path Mt indicated by the progress data D1, passage period T1 in which the vehicle VH passes through each of the one or more sections Sc is recorded. In addition, the schedule indicated by the schedule data D2 includes a scheduled period T2 at which the vehicle VH passes through each of the one or more sections Sc. As the second condition, the control unit 21 determines whether or not the passage period T1 stored in the movement path Mt indicated by the progress data D1 is later than the scheduled period T2 indicated by the schedule data D2 for each of the one or more sections Sc. Alternatively, the control unit 21 of the information providing device 20 may determine, as a second condition, whether the passing speed of the vehicle VH in a certain section is lower than the limiting speed of the section. When it is determined that the passing speed of the vehicle VH is lower than the speed limit of the section, the control unit 21 may detect the section as the second section Sc2.

In S7, the control unit 21 of the information providing device 20 controls the second section Sc2 detected by S6 to change the display mode of the second section Sc2 on the movement path Mt indicated by the progress data D1. Specifically, the control unit 21 of the information providing device 20 transmits information indicating the determination result in S6 to the terminal device 30 via the communication unit 23. For example, the control unit 41 transmits, on the movement path Mt, information indicating a section corresponding to the second section Sc2 to the terminal device 30.

In the present embodiment, the terminal device 30 receives, via the communication unit 33, information indicating a section corresponding to the second section Sc2 transmitted from the information providing device 20 in S6. The control unit 31 of the terminal device 30 changes the display mode of the section corresponding to the second section Sc2 on the movement path Mt displayed on the display as the output unit 35. The display mode of the second section Sc2 can be arbitrarily changed as long as the second section Sc2 can be distinguished from the sections other than the second section Sc2 and the first section Sc1. For example, the control unit 31 changes the color of the second section Sc2 on the movement path Mt to a different color from the section other than the second section Sc2 and the first section Sc1, and outputs the changed color. The control unit 31 may make the second section Sc2 wider on the movement path Mt than the first section Sc1. Alternatively, the control unit 31 may output the second section Sc2 on the movement path Mt by a broken line.

As described above, the information providing device 20 according to the present embodiment acquires the schedule data D2 indicating the schedule until the vehicle VH is delivered, detects, as the second section Sc2, a section satisfying the second condition that is different from the first condition based on the result of comparing the acquired schedule data D2 with the progress data D1, and further performs control for changing the displaying mode of the second section Sc2 on the movement path Mt indicated by the progress data D1 for the detected second section Sc2.

According to the present embodiment, when there is a section in which a delay or the like has occurred during transportation of the vehicle VH, the displaying mode thereof is further changed. Therefore, the user U1 can be assured that the system 10 recognizes the delay even when the delay occurs during transportation. Consequently, it is possible to further reduce the possibility that the user U1 feels dissatisfaction with the progress of the delivery of the vehicle VH.

As a modification of the present embodiment, the control unit 21 of the information providing device 20 may perform control of displaying the second section data d2 related to the second section Sc2 when the user U1 performs an operation of selecting the second section Sc2. The terminal device 30 receives a manipulation of the user U1 specifying the second section Sc2 in the movement path Mt on the map. The operation of specifying the second section Sc2 is the same as the operation of specifying the first section Sc1 by the user U1, and therefore the explanation thereof is omitted.

The reason why the transportation of the vehicle VH is delayed may be, for example, a case where a truck carrying a vehicle VH is caught in a traffic jam, a case where a plurality of vehicles including a vehicle VH are delivered to a plurality of stores by a single truck, and a case where it takes a long time to unload at a store where the cargo is stopped because the order of the cargo is incorrect.

When the control unit 21 of the information providing device 20 detects that the second section Sc2 has been designated by the user U1, the second section data d2 is generated. The second section data d2 may be arbitrarily generated. For example, the control unit 21 acquires congestion information from an external server or the like, refers to the acquired congestion information, determines whether the delay is caused by the congestion, and generates information indicating the determined outcome as the second section data d2. Alternatively, the control unit 21 may acquire, from the vehicle VH, data indicating the times of stay in the respective stores, and generate the second section data d2 based on the acquired data. The control unit 21 may include, in the second section data d2, an apology for the occurrence of the delay. The generated second section data d2 is transmitted to the terminal device 30 via the communication unit 23. The terminal device 30 receives the second section data d2 transmitted from the information providing device 20 via the communication unit 33. The control unit 31 of the terminal device 30 displays the received second section data d2 in the vicinity of the section corresponding to the second section Sc2 on the movement path Mt displayed on the display as the output unit 35.

According to this modification, information about the second section Sc2 specified by the user U1 is displayed for the second section Sc2. Specifically, the reason for the delay of the vehicle VH in the second section Sc2 is displayed. Therefore, the possibility that the user U1 feels dissatisfaction is further reduced because the user U1 knows the reason for the delay even when the transportation of the vehicle VH is delayed.

In the present embodiment, the flowchart is a flowchart that controls changing the display mode of either the first section Sc1 or the second section Sc2 by processing from S2 and subsequent processing after the progress data D1 is output to the terminal device 30 in S1. However, before outputting the progress data D1 obtained in S1 to the terminal device 30, the control unit 21 of the information providing device 20 may perform processing of S2 to S3 and the processing of S4 to S6 on the progress data D1, and perform the processing of changing the display mode of the first section Sc1 and the second section Sc2 on the movement path Mt indicated by the progress data D1. The resulting data indicating the movement path Mt′ with the changed display mode of the first section Sc1 and the second section Sc2 may be output to the terminal device 30 as progress data D1′. Thus, the frequency of communication between the information providing device 20 and the terminal device 30 can be reduced.

The present disclosure is not limited to the embodiment described above. For example, blocks shown in the block diagram may be integrated, or a block may be divided. Instead of executing the steps shown in the flowcharts in chronological order according to the description, the steps may be executed in parallel or in a different order, depending on the processing capacities of the devices that execute the steps, or as necessary. Other changes may be made without departing from the scope of the present disclosure.

For example, in the present embodiment, the information providing device 20 and the terminal device 30 communicate with each other to perform data processing, but by configuring the information providing device 20 according to the present embodiment as a program that operates on the terminal device 30, the function of the information providing device 20 may be executed as an application on the terminal device 30.

What is claimed is:

1. An information providing device comprising a control unit that acquires progress data indicating a movement path of a vehicle, from when the vehicle purchased by a certain user is shipped, to when the vehicle is delivered, and outputs the progress data that is acquired to a terminal device of the user, wherein the control unit detects, from among one or more sections included in the movement path, a section that satisfies a predetermined first condition as a first section, and performs control for changing a display mode of the first section on the movement path indicated by the progress data, with respect to the first section that is detected.

2. The information providing device according to claim 1, wherein the control unit takes a point where the vehicle is to be delivered as a destination, and determines, as the first condition, whether a traveling direction of the movement path is different from a direction toward the destination, for each of the one or more sections.

3. The information providing device according to claim 1, wherein the control unit monitors a moving speed of the vehicle, and determines, as the first condition, whether the moving speed of the vehicle is lower than a threshold value, for each of the one or more sections.

4. The information providing device according to claim 1, wherein the control unit acquires schedule data indicating a schedule until the vehicle is delivered, detects a section satisfying a second condition that is different from the first condition as a second section, based on a result of comparing the schedule data that is acquired with the progress data, and further performs control for changing a display mode of the second section on the movement path indicated by the progress data, with respect to the second section that is detected.

5. The information providing device according to claim 4, wherein:
a passage period at which the vehicle passes through each of the one or more sections is recorded in the movement path indicated by the progress data;
a scheduled period for the vehicle to pass through each of the one or more sections is included in the schedule indicated by the schedule data; and
the control unit determines, as the second condition, whether the passage period recorded in the movement path indicated by the progress data is later than the scheduled period indicated by the schedule data, for each of the one or more sections.
